(19) United States
(12) Patent Application Publication
(10) Pub. No.: US 2007/0050309 A1
(43) Pub. Date: Mar. 1, 2007

(54) Computerized third party negotiation

(76) Inventor: John D. Kettelle, Arlington, VA (US)

Correspondence Address: BRAD CLOSE;TIGHE PATTON, PLLC, 1747 PENN. AVE. NW, SUITE 300, WASHINGTON, DC, 20006-4604, US

(21) Appl. No.: 11/502,576

(22) Filed: Aug. 10, 2006

Related U.S. Application Data
(60) Provisional application No. 60/708,272, filed on Aug. 15, 2005.

(51) Int. Cl. G06Q 99/00

(52) U.S. Cl. 705/80

(57) ABSTRACT

A computerized third party where each side submits a list of issues to be addressed, and then the computer then reports the combined list to both sides. Each side then submits to the computer a value function defined on all the factors in the combined list, and also enters the minimum acceptable value that it requires for a deal. The computer then computes the set of deals in which any payoff for one side is accompanied by the largest possible payoff for the other. It then reports to both sides whether there is room for a deal—whether there are any deals that meet each of their minimum requirements.

This patent application claims priority to U.S. provisional application No. 60/708,272, Computerized Third Party Negotiation, filed Aug. 15, 2005.

### BACKGROUND

One of the most frustrating things about a negotiation is that each principal has private information which is central to a sound agreement but can at the same time be folly to share directly with the other principal/side. For example, for the negotiation of a price, the seller should not start by telling his prospect the lowest price he is prepared to accept, nor should the buyer tell the seller the highest price he is prepared to pay. Clearly, if there is in fact room for a deal, whoever first conveys this information is conceding the excess to the other party.

A conceivable solution to this frustrating situation is for the two principals to find a human third party (HTP) with whom they can both confide. The problems with humans have proved unfortunately obvious, particularly in very important cases. Either side has to be concerned about the risk that the HTP may be a secret ally with the other side. Even if that risk can be accepted, there is a hazard that the HTP, who needs to be intimately familiar with the relevant secrets of both sides, may reveal clues about those secrets by accident. If the issue has any real complexity, the HTP will need a corresponding amount of personal expertise, not only on how to negotiate, but also on the details of the issues. Real complexity can put a serious burden on the third party, and any large staff of the HTP multiplies all the above problems.

Other difficulties with the prior art also exist, some of which will be apparent upon further reading.

### SUMMARY OF THE INVENTION

In one embodiment of the computerized third party each side submits a list of issues to be addressed, and the computer then reports the combined list to both sides. Each side then submits to the computer a value function defined on all the factors in the combined list, and also enters the minimum acceptable value that is required for a deal. The computer then computes the set of deals in which any payoff for one side is accompanied by the largest possible payoff for the other. It then reports to both sides whether there is room for a deal, whether there are any deals that meet each of their minimum requirements.

If there is not room for a deal, one side can be informed of such in a variety of different ways. They can be told flat out that no deal can be reached, or they can be informed if certain factors in the deal have been reached, while others have not. Since some negotiations are more sensitive than others, the determination on whether the deal can be divisible in this manner should be determined ahead of time.

In one embodiment, the present invention provides for a computer negotiation method that comprises at least one computer, and two or more sides. Each of the sides submits a list of issues to be addressed to the computer, and then the computer reports a combined list to both sides. The list contains relevant factors to a negotiation. Each of the sides then adds a value function defined on the relevant factors in the combined list, including a minimum acceptable value that it requires for each the relevant factors. The computer then computes a set of deals in which any payoff for one of the sides is accompanied by a largest possible payoff for the other of the sides, and the computer then reports to the sides whether there a possible deal that meet each of the minimum acceptable values.

In particular embodiments, if there is not the possibility of a deal, the computer reports minimum acceptable values that were met. The portion of the relevant factors are pre-determined by the computer, and in some cases the computer reports to the sides whether there is the possible deal if all of the two or more sides agree that the possible deal should be reported.

In other particular embodiments the CTP system is paid by the sides via a flat rate pricing. In some cases the CTP system is paid by the sides via a percentage of excess in any negotiation. Updates to the method are allowed if there is no the possible deal. Each side of the two or more sides may have two or more entities, such as multiple buyers and multiple sellers.

In still other embodiments, if there is possible deal, the sides are penalized for not accepting the possible deal. The list contains at least one fake issue. The list is confirmed by the two or more sides prior to adding the value function. The list is redone, if not approved by the two or more sides, and additional specifics asked for after a determination of a deal has been made. Also variations on a deal can be presented.

In other particular embodiments, the two or more sides may request information outputs concerning the computer negotiation method, and other parties in the two or more sides are informed about the requested information outputs. If there is possible deal that the computer negotiation method automatically splits any excesses in the deal between the two or more sides and the excesses are divided equally amongst two or more sides. If there is a possible deal, a second list is compiled with specific relevant factors.

In another embodiment the present invention provides for a computer negotiation method that comprises at least one computer, and a first side and a second side. The first side submits a list of issues to be addressed to the computer, and then the computer reports the list to the second side. The second side approves the list, and the list thusly contains relevant factors to a negotiation. Each of the first side and the second side adds a value function defined on the relevant factors in the list, including a minimum acceptable value that it requires for each the relevant factors. The computer then computes a set of deals in which any payoff for one of the sides is accompanied by a largest possible payoff for the other of the sides, and the computer then reports to the sides whether there is a possible deal that meets each of the minimum acceptable values.

Other embodiment will be apparent upon further reading of the application.

### DETAILED DESCRIPTION OF THE INVENTION

The present invention uses a computerized third party (CTP) in negotiations. As used herein, third party in reference to the computer refers to the autonomous nature of the computer, and more than two sides may used the CTP simultaneously. One of the most frustrating things about a negotiation is that each principal has private information which is central to a sound agreement but can at the same time be folly to share directly with the other principal. For example, for the negotiation of a price, the seller should not start by telling his prospect the lowest price he is prepared to accept, nor should the buyer tell the seller the highest price he is prepared to pay. Clearly, if there is in fact room for a deal, whoever first conveys this information is conceding the excess to the other party.

In many negotiations, there will be an array of issues and corresponding sets of values placed by either side on the associated possible deals that might be struck. For either side to convey its version of these values directly to the other can be similarly damaging. The present invention not only reduces this risk to both parties and also provides an array of constructive processes that first permit the parties to determine whether there is in fact room for a deal, and can also follow a constructive path to a more efficient deal.

If two people are trying to cooperate—such as one person trying to buy an object from the other, there are famously some facts that it is counter-productive for them to tell each other directly. In this purchase situation, for example, the only relevant parameter may be the price. The last thing the buyer should do is to truthfully announce the most he is prepared to pay. And likewise for the seller to announce the least he is prepared to accept. These limiting amounts are professionally called the reserve positions of the sides.

A common way to deal with this problem has been for them both to share their reserve positions with a mutually trusted third party, who may somehow help them both find out whether there is indeed room for a deal, and then help them arrive at a mutually comfortable agreement. Human third parties can have problems. They may be hard to find, not conveniently available, possibly untrustworthy, prone to make mistakes, and in danger of being sued.

In this very simple case the two parties can each privately access the CTP, and enter their reserve positions. The CTP will have a protocol regarding information it supplies. Normally it will supply information to either side only if both sides agree for the CTP to do so and normally that information will be issued to both sides. In this example, the first question would normally be, “Is there room for a deal?”. If there is, the two parties can then use the CTP to negotiate how to split the excess (the buyer's reserve price minus the seller's), with the CTP offering some general-purpose ways to split the excess, such as evenly.

A CTP can also be paid for taking part in the negotiations in a variety of methods, such as a flat rate, or as a percentage of any excess in the deal. A flat rate is more useful when dealing with less fungible deals. Paying a percentage of any excess will be attractive to users since they are not paying until a deal has been favorably reached.

In more complex negotiations there will typically be more than one parameter at issue, and the value of any result to each individual party will be his own individual function of those parameters. To deal with this, the CTP concept includes two processes. Each party submits to the CTP a list of what he considers relevant parameters. This can include being prompted by elements on a pre-determined list. To reduce intelligence this might supply to the other party, this list can include a few parameters which are in fact of no significant value. The CTP then publishes the combined list to both sides. Extra steps in the process can be added to confirm an acceptable list amongst the parties or revise the list until it is acceptable. Each side then tells the CTP his value function defined on the combined list, and stipulates a minimum value (essentially like a reserve price) necessary for a deal. The CTP then uses this data to compute what negotiation theorists call the Pareto frontier, i.e., a plot of the most value one party can get, as a function of what value can be provided to the other party. The CTP then helps the two parties settle on a result (better than either had required) on the Pareto frontier in the same fashion outlined above for the single-parameter case. Because deciding on all these value functions can be complex, the CTP can provide a simple preliminary round to determine early on whether (a) there is no realistic hope for a deal, or (b) that there is a least one agreement that each side would prefer to “no deal”.

The above process for two parties generalizes routinely to any number of parties. For example, if there are three parties, the CTP can generate a three-dimensional Pareto Frontier, and provide similar ways for the three parties to share the excess.

Above, two processes for computing the aforementioned Pareto frontiers have been identified. If the negotiation involves sharing continuous variables, like tea or oil, the CTP can sometimes compute the Pareto frontier (for any number of parties) using linear programming. If it involves only discrete items, like cars or cities, integer programming can often be used. If it involves both, a combination of the two can help.

For a CTP to be accepted as a viable device by the principals, it needs: (1) To convince both sides that it is reliable from a security standpoint. (2) To elicit relevant information from each side. (3) As it receives this information, to determine whether there is in fact room for a negotiated solution (a deal), the alternative being for the two parties to discontinue negotiations pending some change in the situation. (4) If there is indeed room for a deal, to help the parties converge on one that is in some sense optimal, and that properly balances the interests of the two sides.

There needs to be a computer, and secure access to and from the computer, for each of the parties. There needs to be clear and dependable protocols for communicating with the computer, and there has to be properly-designed software. The extent of these requirements depends on the issues and the parties. For a single real estate transaction a single laptop, with some software and protocols to limit outputs to the separate parties, will certainly suffice. For a complex international negotiation (for example, the “peace process” between Israel and Palestine, with some involvement with other countries such as the US, Syria, and perhaps Saudi Arabia) one might need very secure access to the computer itself, and the communications would need to be encrypted.

Human intervention can also be coupled to the computer. For example, the computer might be guarded by sentries from each side, each of whom would have the unilateral ability to erase all the data, and each of whom would guarantee that neither side has any access to the computer (except as provided by protocols).

When used, each side inputs its value function defined on all relevant parameters, and the computer then orchestrates a mutual search for an efficient solution acceptable to both sides. Note that these “value functions” are largely potential trade-offs among relevant parameters. In the Israel-Palestine example, one might trade off an expansion of the West Bank against reduction of residual settlements. Note that, even without the CTP, anticipating such trade-offs is normal homework in preparing for any negotiation.

In one embodiment, an early phase of the CTP is also known as the Feasibility Mode. In this phase each side submits a list of issues to be addressed, and then the computer then reports the combined list to both sides. Because learning that one side considers some factor particularly relevant, each side will have been free to include some factors that were in fact unimportant. In some cases the list can also be modified by the parties. Each side then submits to the computer a value function defined on all the factors in the combined list (the irrelevant ones being ignored, because this set of inputs will not be automatically revealed to the other side), and also enters the minimum acceptable value that it requires for a deal. The computer then computes the set of deals in which any payoff for one side is accompanied by the largest possible payoff for the other. It then reports to both sides whether there is room for a deal, that is, whether there are any deals that meet each of their minimum requirements. Once this phase has been reached, an additional element can be to ask the sides for more specifics to present the best deal possible as well as close variations. In this manner, some of the details are saved for cases where there is room for a deal.

If the computer reports there isn't room for a deal, then the sides can either break off the negotiation altogether or cycle back to an earlier step, presumably with lower requirements. There is the possible inclusion of an additional party—one who has an exogenous stake in the success of an agreement. This issue can also be dealt with either by including him in the negotiation from the beginning, or including him at a later date, whether or not there is already room for a deal.

In some embodiments, the next phase is the collaborative phase, where the parties try to agree on how to share the excess beyond the minimum payoffs that have already been assured. On the way to this objective, either side may request information outputs (and who should get them) from the computer. The request itself (but not the requested output) will be automatically relayed to the other side, and will be granted only with his concurrence. The sides could agree to share the entire set of Pareto points (that is, the sets of conditions that generate the payoffs, not the payoffs themselves), or each could allow the other side to see only the array of its own payoffs, reducing what might some call the “jealousy” factor. Also the sides could start by asking to see only one candidate point, for example, the one somehow closest to the midpoint of the acceptable solutions, and by mutual agreement explore the Frontier step by step.

In some embodiments the next phase is the deciding phase. Ideally, the negotiation will have generated at least one deal. Before this deal is finally ratified, there could be added a “time-out”, to digest the apparently-best deal. Whether it deserves minutes, hours, days, or weeks, depends on the circumstances, but in any case the deal's payoff, and its very structure, may have turned out to be somewhat of a surprise. This may warrant some additional thoughts that could lead to an even better deal (or avoidance of an unforeseen flaw in somebody's logic).

There may be a modification that would provide a very large gain for one side in exchange for a much smaller loss for the other. This might be addressed by some kind of side payment beyond those already embedded in the Frontier or, simply by giving the conceding party a chance to be generous. If security permits, the negotiation can be completed remotely and secretly.

In some embodiments there needs to be penalties for backing out. It is conceivable that one side could simply be using the CTP negotiation as a fishing expedition—simply to learn more about the other side's attitudes. One inherent protection against this will be the cost of the sham negotiation itself. If this is not enough, each side might be required to put in some kind of initial deposit which would be forfeited if he arbitrarily rejected an agreement which had met all of the criteria entered during the course of the process.

An illustrative example of how the CTP follows in how to how to divide a pizza:

Suppose two men (Tom and Dick) enter a pizza parlor, and thoughtlessly order a pizza, specifying that one side will be mushrooms and the other side pepperoni. When they sit down to eat, they decide to make a real problem of just how to share it. They start by agreeing to require an “equi-max” solution, to wit:

Each man should get the same fraction of his own perceived value of the whole pizza, and this common fraction should be maximized.

Now suppose their values about mushrooms and pepperonis are as follows:

| | Mushrooms | Pepperoni |
|---|---|---|
| Tom | .6 | .4 |
| Dick | .1 | .9 |

If Tom and Dick were normal, they would likely end up with Tom simply getting the mushroom side and Dick the pepperoni. By use of the present invention, they can satisfy the above equi-max sharing conditions. It gives them the following result:

| | Mushrooms | Pepperoni | Total Value |
|---|---|---|---|
| Tom | 1.0 | .23 | .69 |
| Dick | None | .77 | .69 |
| Total | | | 1.38 |

A computer can solve this problem, for any number of different flavors, and for any number of people who have a claim on the pizza, with a typical linear programming package. For the two person problem, the computer can derive a continuous Pareto Frontier, a plot of the most value Tom can get as a function of what Dick would get.

The “normal” resolution, Tom getting all the mushrooms and Dick all the pepperoni, gives a larger total (but obviously not equally shared) value of 1.5. This suggests the issue of side-payments. If one player happens to be a lot hungrier than the other, there may be room for a side payment. Similarly if one player is a lot richer than the other.

Possible outcomes of a negotiation between parties A and B are plotted below:

[image]

For each lettered point, there is at least one numbered point that is better for both A and B. For example, 2 is better than a, 4 is better than both b and c. The numbered points are called “undominated,” and constitute the Pareto Frontier. To the extent assests can be continuously divided (such as in the Pizza Problem), the Pareto Frontier can be a continuous curve. When there are only two parties, the resolution obviously wants to be on the Pareto Frontier. When there are more than two, there can be all kinds of ways that a subset of the parties can cooperate to the detriment of the other parties.

A second illustrative example is the dividing of an estate. Assume now that Dick and Tom are brothers, and have been left an estate, with the only stipulation in the will that they are to have equal rights. Assume there are 5 items, with the following respective values to Dick and Tom:

| | Value to | Value to | Ratio |
|---|---|---|---|
| Item | Dick | Tom | Dick/Tom |
| 1 | 10 | 3 | 3.33 |
| 2 | 8 | 5 | 1.60 |
| 3 | 6 | 9 | 0.67 |
| 4 | 4 | 1 | 4.00 |
| 5 | 2 | 7 | 0.29 |
| Totals | 30 | 25 | |

There are several sharing ways that can make sense. Clearly any sensible way involves allocating items with higher ratios to Dick, and lower ratios to Tom.

Issues include the relative wealth of the two men and the relative strength of their sentimental feelings versus the market values of the items.

When there are more than two siblings, there can be all kinds of ways that a subset of the siblings can cooperate to the detriment of the other siblings. In this case various subsets can use the CTP for this purpose. This ability for the various players to form coalitions is another aspect of the CTP concept.

For the division of discrete assets, there are two standard ways that do not require third parties. If only one party has accurate knowledge of the other party's values, he will have an advantage as the divider, by the same logic obtained in the pizza problem. On the other hand, if there is one item which is of great value to one side (and this fact is not understood by the other), it can be very important (and a huge advantage) for that side to be the chooser. These problems can make divide and choose a very poor procedure.

The advantage of first pick can be addressed by auctioning off the first pick. This “fix” becomes unfair to the player who would have the smaller advantage, because when he drops out of the auction the other player is getting the bargain of the difference of the two advantages.

Possible applications for the CTP include government agreements, such as peace treaties, armistice negotiations, and intelligence sharing. Non-government applications include; labor management contracts, acquisitions and mergers, multi-team player trades, litigation settlements, and real estate transactions.

In military conflicts, the conclusion of a war is in fact a two-step process, the cessation of fighting, typically called an armistice, which is to a first approximation usually surrender by one side, and a follow-on detailed set of actions, part of which is sometimes called a peace treaty. As the CTP process gets established it can help with each step, and provide a smoother connection between them.

In armistices there are good examples from both World Wars and from the follow-on Cold War. The U.S. WWI intercession in April, 1917 took only a few months to make it clear to both sides that an Allied victory was only a question of time. A short set of agreed conditions could very likely have led to an armistice at least six months before November of 1918. The nature of this armistice agreement would have concluded: details about boundaries, first order agreements about the nature of the surviving German government; and some preliminary provision for reparations and post-war reconstruction.

During WWII in Italy it may be an open question whether the armistice with Italy should have been with Mussolini or with the putative post-Mussolini Italian government. In either case, the armistice should have been negotiated more quickly. It might well have provided for an effective “flip-flop” of the Italian military (including its battleship Roma) to join the Allies in the continuing war against Germany.

During the Cold War, the otherwise robust situation of Mutually Assured Destruction (MAD) had a significant chink in it—the possibility that one side or the other might accidentally launch a single missile that would trigger the carefully-planned MAD event. The travel time of a ballistic missile between Moscow and Washington is about 60 minutes. This is still a possible tragedy, and there seem to be ways the CTP could avert it. One detail is to place the computer itself into a stationary orbit.

For peace treaties, the Treaty of Versailles is normally considered to have been a primary condition that permitted the rise of Hitler and the consequent initiation of WWII. The peace arrangements as WWII ended had differences and similarities. The differences included the cooperative restructuring of both Germany and Japan by the Western Allies and particularly by the United States. One can make a case that these successful arrangements (such as the Marshall Plan in Europe and benevolent administration of Japan by McArthur's temporary government) could well have been further enhanced by CTP arrangement in which the resulting deals could have even more cooperatively fashioned.

For non-government labor-management contracts there are plenty of non-zero-sum elements. For each element of a deal the values to the union may have a very different structure from the costs to management. A central set of issues—namely salaries or hourly rates—can be an exception to this, but retirement benefits, vacations and holidays, sick leave, health benefits and overtime premiums typically have significant differences in costs to management versus values to labor. It has already been noted that it can be counterproductive for one side to tell the other the values it puts on various components of a deal, so here is a good role for CTP.

Explicitly facing this labor issue in the CTP context highlights another well-known aspect of labor-management contracts—mainly different contracts for different categories of labor. For example, retirement benefits versus current income may have different relative values for airline flight personnel versus maintenance workers. This illustrates the need for a many-sided (rather than two-sided) CTP structure.

In acquisitions and mergers there are a number of components of a merger transaction: How much of the stock of the acquired company will be paid for in cash, or in stock of the acquiring company? What happens to key figures of the acquired company? (For example, the very people negotiating the purchase.)

A central element of a merger discussion is each side's estimate of the synergy of the merger—the extent to which the new entity will be worth more than the sum of the original parts. The CTP may provide an efficient way for the two companies to share enough information so that they can separately form their estimates of the overall payoff of the merger, without directly giving each other information that can hurt them if the merger doesn't go through. Again, the formation of coalitions here can be a rich ingredient.

A closely-related kind of inter-company negotiation is the examination of ways companies can find some mixture of cooperation and competition. A legitimate example would be ways to combine shipments; an illegitimate one (from the government's point of view) would be ways to fix prices.

For player trades, an example of the National Football League is used. The manager of an individual team could tell a league-wide CTP the value to that team of various combinations of named players with particular emphasis on players it would like to acquire and those of its own players that it perceives would be more useful to other teams in the league. If talking about just two teams looking for a deal, the negotiation structure would be clearly similar to that of the inheritance example in the previous section; but suppose for example there are four teams involved, with the following interests:

Team A has a surplus fullback and needs a better tight end;

Team B has an extra center and needs a better guard;

Team C has an extra guard and needs a good fullback;

Team D has an extra tight end and needs a center.

There is likely to be an attractive deal for all four teams, and all four individuals, that might not even be perceived, let alone negotiated, without a league-wide CTP.

For real estate the only time either side should tell the other his reserve price is when he is desperate, since this gives the other side all the room, the difference between the two reserve prices. For a given house that is for sale, there will typically be a set of possible buyers; and for a given buyer, there will typically be a set of possible houses worth considering. Before he makes a serious offer, a buyer needs to learn what houses might make sense for him, and the owner of a house needs to do similar homework before deciding on his pricing strategy. Real estate agents (whether or not they are realtors) make their money by helping both sides with this homework.

The CTP can make this whole process efficient. In one embodiment the steps include that all houses will be listed on a web site and each seller will secretly enter, and occasionally update, his reserve price (ps). A prospective buyer will secretly enter, and occasionally update, his reserve price (pb). If pb>ps, then, subject to issues such as inspections, both sides will automatically have a contract for a price half-way between ps and pb. If a seller has an agent, his ps must be large enough to include his agent's commission; and if a buyer has an agent, his pb must be the net to the seller after his agent's commission.

In another illustrative example, in a simple, one-dimensional negotiation, the CTP invention will help when there are two or more groups who have some common interests. In the case of only two parties and a single issue (such as the price of an object). In step 1, the seller enters into a computer the least price that he is prepared to accept, and the buyer enters the highest price he is prepared to pay. The in step 2, the CTP compares the two prices, and tells both sides whether there is room for a deal.

If there is room for a deal, or even excess, then a deal is indicated and a determination is made on how to divide the excess. This could involve repeating steps 1 and 2 where the negotiation is how to divide the excess. This process can be repeated several times as needed. Also, an option to split the difference can always be offered or accepted. If there appears to be no room for a deal, then the negations can end. However, each side has learned something new in that they cannot both get their initial requirements. So they both might chose to try the negotiation again with altered parameters.

For complicated negotiations, it becomes more important for the process to first focus on whether or not any possible deal can be made within the parameters, including possible fake parameters. The CTP publishes the combined list to all the parties and each party then decides the limits of acceptable deals. The CTP then computes whether there is room for a deal. If the answer is no, the CTP can facilitate an exploration of whether the parties want to try harder. This can include by inviting them all to lower their minimum overall required value, or inviting them to lower their requirements on certain details. If the parties have time available for a prolonged negotiation, this step can permit the parties to take some time before abandoning the effort to make a deal. If there is room for a deal, the CTP computes what negotiation experts call the Pareto frontier. This is the set of deals such that for a given payoff to one side, the payoff is maximized for the other.

In one embodiment, the present invention provides for a computer negotiation method that comprises at least one computer, and two or more sides. Each of the sides submits a list of issues to be addressed to the computer, and then the computer reports a combined list to both sides. The list contains relevant factors to a negotiation. Each of the sides then adds a value function defined on the relevant factors in the combined list, including a minimum acceptable value that it requires for each the relevant factors. The computer then computes a set of deals in which any payoff for one of the sides is accompanied by a largest possible payoff for the other of the sides, and the computer then reports to the sides whether there a possible deal that meet each of the minimum acceptable values.

In particular embodiments, if there is not the possibility of a deal, the computer reports minimum acceptable values that were met. The portion of the relevant factors are pre-determined by the computer, and in some cases the computer reports to the sides whether there is the possible deal if all of the two or more sides agree that the possible deal should be reported.

In other particular embodiments the CTP system is paid by the sides via a flat rate pricing. In some cases the CTP system is paid by the sides via a percentage of excess in any negotiation. Updates to the method are allowed if there is no the possible deal. Each side of the two or more sides may have two or more entities, such as multiple buyers and multiple sellers.

In still other embodiments, if there is possible deal, the sides are penalized for not accepting the possible deal. The list contains at least one fake issue. The list is confirmed by the two or more sides prior to adding the value function. The list is redone, if not approved by the two or more sides, and additional specifics asked for after a determination of a deal has been made. Also variations on a deal can be presented.

In other particular embodiments, the two or more sides may request information outputs concerning the computer negotiation method, and other parties in the two or more sides are informed about the requested information outputs. If there is possible deal that the computer negotiation method automatically splits any excesses in the deal between the two or more sides and the excesses are divided equally amongst two or more sides. If there is a possible deal, a second list is compiled with specific relevant factors.

In another embodiment the present invention provides for a computer negotiation method that comprises at least one computer, and a first side and a second side. The first side submits a list of issues to be addressed to the computer, and then the computer reports the list to the second side. The second side approves the list, and the list thusly contains relevant factors to a negotiation. Each of the first side and the second side adds a value function defined on the relevant factors in the list, including a minimum acceptable value that it requires for each the relevant factors. The computer then computes a set of deals in which any payoff for one of the sides is accompanied by a largest possible payoff for the other of the sides, and the computer then reports to the sides whether there is a possible deal that meets each of the minimum acceptable values.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the inventions which, is to be given the full breadth of the claims appended and any and all equivalents thereof.

What is claimed is:

1. A computer negotiation method comprising:
at least one computer; and
a plurality of sides;
wherein each of said sides submits a list of issues to be addressed to said computer, and then said computer reports a combined list to all sides, wherein said list contains relevant factors to a negotiation;
wherein each of said sides then adds a value function defined on said relevant factors in said combined list, including a minimum acceptable value that it requires for each said relevant factor;
wherein said computer then computes a set of deals in which any payoff for one of said sides is accompanied by a largest possible payoff the other of said sides;
wherein said computer then reports to said sides whether there a possible deal that meets each of said minimum acceptable values.

2. The method of claim 1, wherein if there is not said possible deal, said computer reports minimum acceptable values that were met.

3. The method of claim 1, wherein said at least a portion of said relevant factors are pre-determined by said computer.

4. The method of claim 1, wherein said CTP system is paid by said sides via a flat rate pricing.

5. The method of claim 1, wherein said CTP system is paid by said sides via a percentage of excess in any negotiation.

6. The method of claim 1, wherein updates to said method are allowed if there is no said possible deal.

7. The method of claim 1, wherein each side of said plurality of sides has a plurality of entities.

8. The method of claim 1, wherein, if there is said possible deal, said sides are penalized for not accepting said possible deal.

9. The method of claim 1, wherein said list contains at least one fake issue.

10. The method of claim 1, wherein said list is confirmed by said plurality of sides prior to adding said value function.

11. The method of claim 1, wherein said list is redone if not approved by said plurality of sides.

12. The method of claim 1, wherein additional specifics are asked for after a determination of a deal has been made.

13. The method of claim 1, wherein variations on a deal are also presented

14. The method of claim 1, wherein said plurality of sides may request information outputs concerning said computer negotiation method.

15. The method of claim 14, wherein other parties in said plurality of sides are informed about the requested information outputs.

16. The method of claim 1, wherein if there is said possible deal that said computer negotiation method automatically splits any excesses in the deal between said plurality of sides.

17. The method of claim 16, wherein the excesses are divided equally amongst the plurality of sides.

18. The method of claim 1, wherein if there is said possible deal, a second list is compiled with specific relevant factors.

19. The method of claim 1, wherein said computer reports to said sides whether there is said possible deal if all of said plurality of sides agree that said possible deal should be reported.

20. A computer negotiation method comprising:
at least one computer; and
a first side and a second side;
wherein said first side submits a list of issues to be addressed to said computer, and then said computer reports said list to said second side;
wherein said second side approves said list;
wherein said list contains relevant factors to a negotiation;
wherein each of said first side and said second side adds a value function defined on said relevant factors in said list, including a minimum acceptable value that it requires for each said relevant factor;
wherein said computer then computes a set of deals in which any payoff for one of said sides is accompanied by a largest possible payoff the other of said sides;
wherein said computer then reports to said sides whether there a possible deal that meets each of said minimum acceptable values.
